(19) United States
(12) Patent Application Publication
(10) Pub. No.: US 2012/0082421 A1
(43) Pub. Date: Apr. 5, 2012

(54) OPTICAL CONNECTOR HAVING INCORPORATED WITH POWER

(75) Inventors: KUO-CHUN HSU, New Taipei (TW); CHIA-PIN LIU, New Taipei (TW); JIA-HAU LIU, New Taipei (TW)

(73) Assignee: HON HAI PRECISION INDUSTRY CO., LTD., New Taipei (TW)

(21) Appl. No.: 13/241,268

(22) Filed: Sep. 23, 2011

(30) Foreign Application Priority Data
Sep. 30, 2010 (TW) 099133435

(51) Int. Cl. G02B 6/36

(52) U.S. Cl. 385/93; 385/92

(57) ABSTRACT

A connector assembly includes an insulative housing having a base portion extending along a longitudinal direction, and a first body and a second body located at opposite sides of the base portion and protruding beyond the base portion along a mating direction thereby defining a first mating cavity therebetween. An optical device is retained on the base portion, with a pair of lens projecting into the first mating cavity. A first terminal group is retained in the base portion with contacting portions located above the lenses in a vertical direction perpendicular to the longitudinal direction and mating direction. A second terminal group is respectively retained in the first and second bodies and arranged as a symmetrical manner with respect to the base portion.

### BACKGROUND OF THE INVENTION

1. Field of the Invention

The present invention relates to a connector assembly, and more particularly to a connector assembly for transmitting optical signal.

2. Description of the Related Art

TaiWan Utility Patent No. 368918 issued to He et al. on Nov. 11, 2009 discloses a connector assembly, which includes an insulative housing, a plurality of conductive terminals received in the insulative housing, an optical device and a metallic shell surrounding the insulative housing. The insulative housing includes a base portion and a mating tongue extending forward from the base portion. The metallic shell surrounds the mating tongue thereby defining a mating cavity for receiving a mating plug therein. The conductive terminals are retained on the base portion, with contacting portions secured on a lower side of the mating tongue and exposed in the mating cavity. The optical device is also retained on the base portion, with an optical member exposed in the mating cavity for receiving optical signals.

The key in optical interconnection mainly relies upon precisely alignment between two coupling lens, i.e. the light emits from a first lens, and then enters into the other lens. If the alignment is altered, the transmission of light therebetween will be negatively affected, in worst case, interrupted.

### SUMMARY OF THE INVENTION

Accordingly, an object of the present invention is to provide an optical connector having incorporated with power.

In order to achieve the object set forth, a connector assembly defines a longitudinal direction and a mating direction perpendicular to the longitudinal direction. The connector assembly comprises an insulative housing having a base portion extending along the longitudinal direction, and a first body and a second body located at opposite sides of the base portion and protruding beyond the base portion along the mating direction thereby defining a first mating cavity therebetween. An optical device is retained on the base portion, with a pair of lens projecting into the first mating cavity. A first terminal group is retained in the base portion with contacting portions located above the lenses in a vertical direction perpendicular to the longitudinal direction and mating direction. A second terminal group is respectively retained in the first and second bodies and arranged as a symmetrical manner with respect to the base portion.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of a connector assembly in accordance with the present invention;

FIG. 2 is an exploded perspective view of the connector assembly shown in FIG. 1;

FIG. 3 is another exploded perspective view of the connector assembly shown in FIG. 1;

FIG. 4 is a partly assembled perspective view of the connector assembly shown in FIG. 1, with metallic shells and a bracket removed;

FIG. 5 is a front view of the connector assembly shown in FIG. 1;

FIG. 6 is a cross-sectional view of the connector assembly shown in FIG. 1 along line 6-6;

FIG. 7 is a perspective view of the connector assembly shown in FIG. 1, seen from a rear side;

FIG. 8 is a rear view of the connector assembly shown in FIG. 1;

FIG. 9 is a perspective view of the connector assembly shown in FIG. 1, seen from a bottom side; and

FIG. 10 is a perspective view of the connector assembly shown in FIG. 1, with the bracket releasing from the connector assembly.

### DETAILED DESCRIPTION OF THE INVENTION

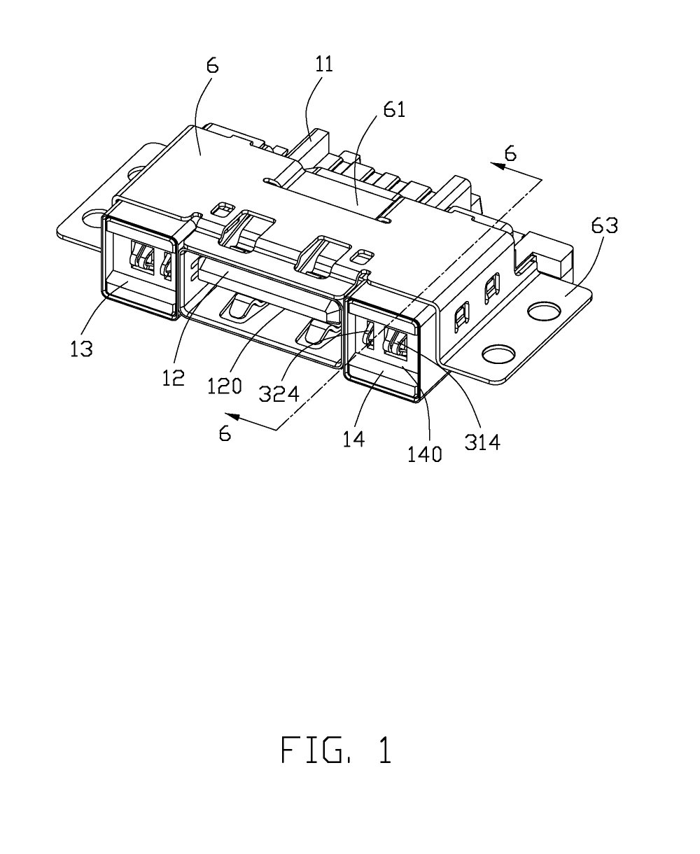

Reference will now be made to the drawing figures to describe a preferred embodiment of the present invention in detail. Referring to FIG. 1 to FIG. 3, a connector assembly made according to the preferred embodiment of the present invention is provided and comprises an insulative housing 1, a first terminal group 3 and a second terminal group 2 received in the insulative housing 1, an optical device 4 retained in the insulative housing 1, a metallic shell 5 surrounding the insulative housing 1 and a metallic bracket 6 enclosing the insulative housing 1.

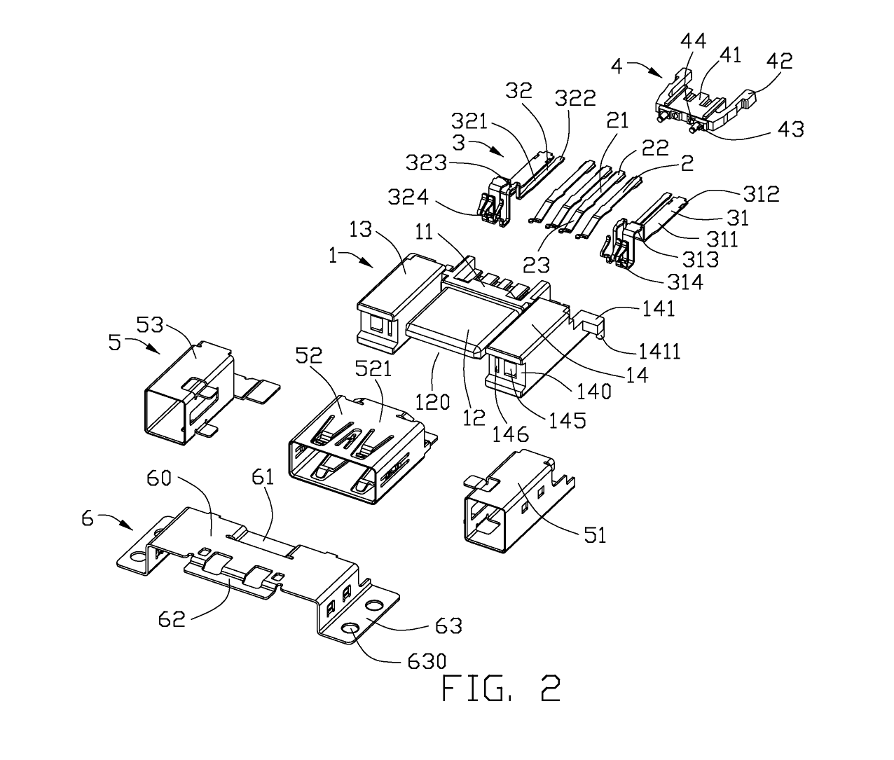

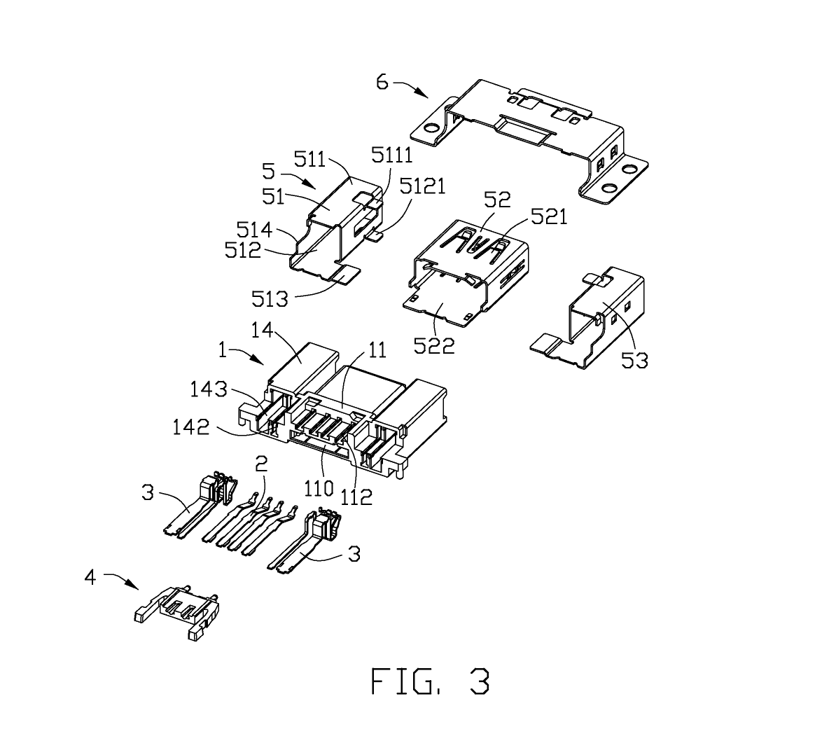

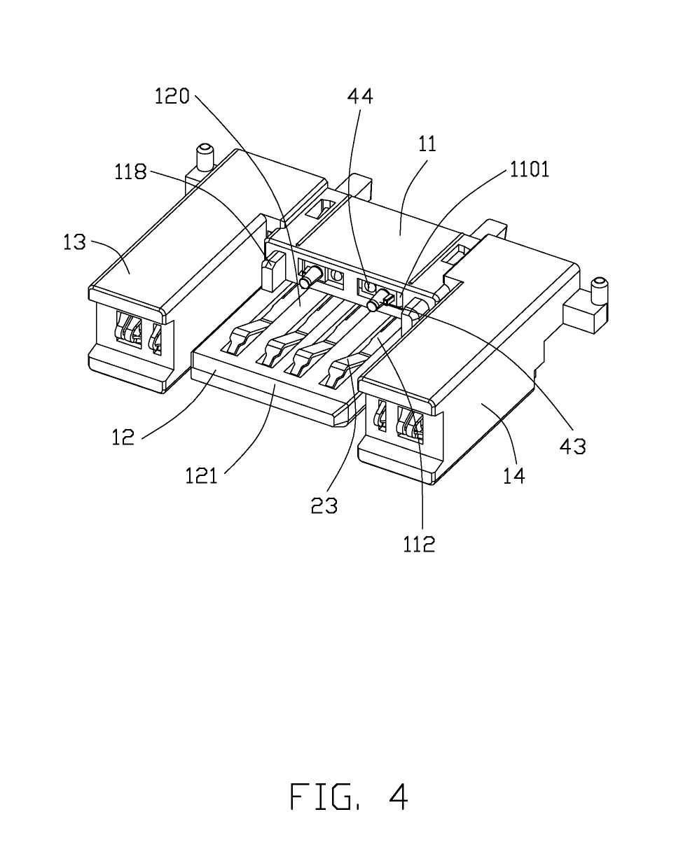

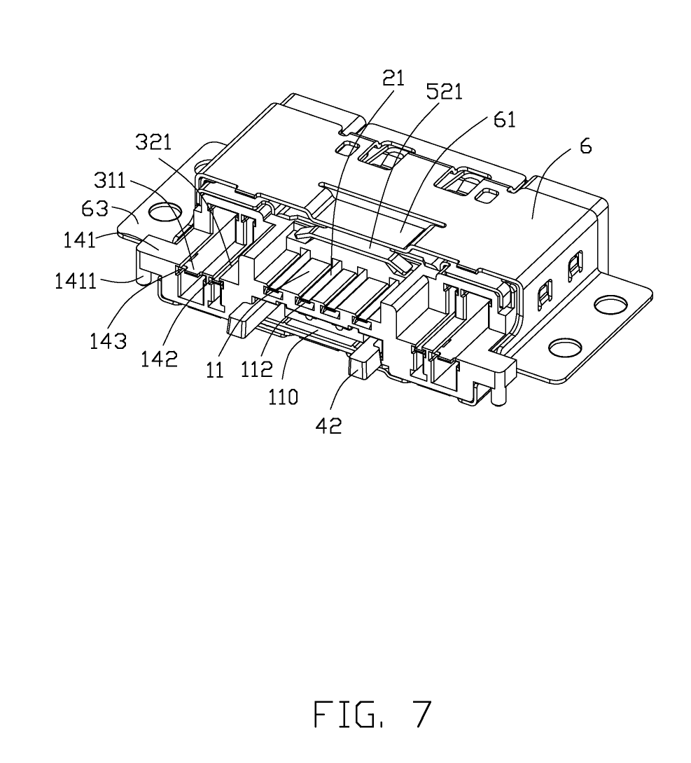

Referring to FIG. 2, FIG. 3, FIG. 4 and FIG. 7, the insulative housing 1 defines a longitudinal direction, a front-to-rear direction perpendicular to the longitudinal direction, and a vertical direction perpendicular to the front-to-rear direction, the front-to-rear direction is also named as a mating direction. The insulative housing 1 comprises a base portion 11 extending along the longitudinal direction and a first body 14 and a second body 13 symmetrically arranged at opposite ends of the base portion 11 and extending along the mating direction. The first body 14 and the second body 13 are configured as a nearly same structure and protrude forwardly from the base portion 11 so as to face to each other and define a first mating cavity 120 therebetween. In this embodiment, the first body 14 and the second body 13 are integrally formed with the base portion 11, while in other embodiments, they can be separately formed individually. The height of the first and second bodies 14, 13 is higher than that of the base portion 11, therefore a step is formed between the first body 14 and the base portion 11, also the second body 13 and the base portion 11. Further, a pair of supporting sections 141 are respectively formed on a lateral side face of the first body 14 and the second body 13, from each of which a mounting post 1411 is formed and extends downwardly for positioning the connector assembly onto a printed circuit board. The supporting sections 141 are hanging on the lateral sides of the insulative housing 1, which make the connector assembly a sink type and a low profile.

The base portion 11 defines an assembling groove 110 extending along the mating direction and communicating with the first mating cavity 120 via an opening 1101 defined at a front end thereof. The optical device 4 is inserted into the assembling groove 110 along the mating direction. The first body 14 defines a first terminal groove 142 extending along the mating direction and defining a first opening 146 at a front end thereof. A first transverse groove 1421 is formed within the first terminal groove 142 and crosses over the first terminal groove 142. The first body 14 also defines a second terminal groove 143 extending along the mating direction and defining a second opening 145 at a front end thereof. A second transverse groove 1431 is formed within the second terminal groove 143 and crosses over the second terminal groove 143. A recess section 140 is formed at the front end of the first body 14 and the first and second openings 146, 145 are both defined within the recess section 140. The structure of the second body 13 is nearly same as the first body 14, therefore detailed description will be omitted here.

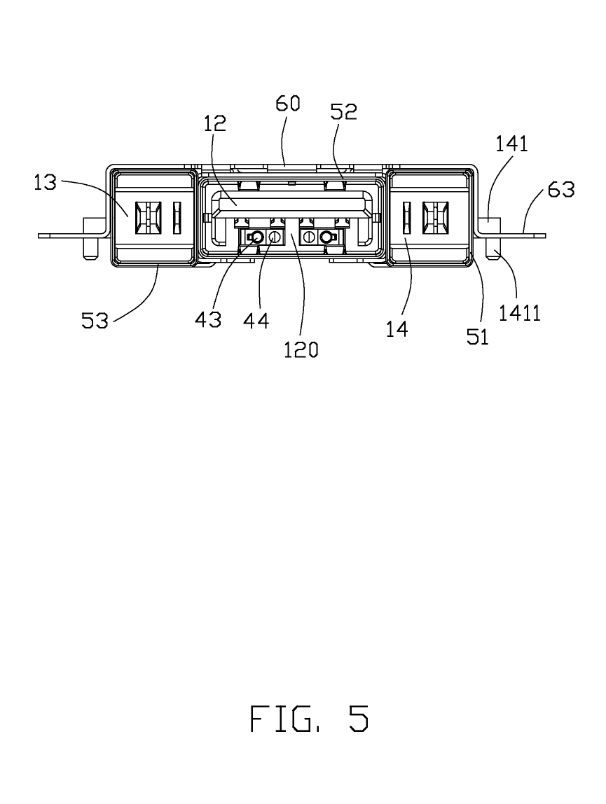

Referring to FIG. 4 and FIG. 5, the base portion 11 forms a tongue plate 12 above the assembling groove 110 and extending along the mating direction so as to be exposed in the first mating cavity 120 and located between the first body 14 and the second body 13. The base portion 11 is spaced to the first body 14 and the second body 13 and leaves intervals therebetween for inserting a mating plug. A plurality of terminal passageways 112 are defined on the base portion 11 and extend forwardly to run through a lower surface 121 of the tongue plate 12. The second terminal group 2 comprises four second terminals configured as a same structure, each of which including a plate shaped body portion 21, a connecting portion 22 extending rearward from one end of the body portion 21 and a contacting portion 23 extending forward from the other end of the body portion 21. The second terminals are inserted into the terminal passageways 112 along the mating direction, with the contacting portions 23 exposed on the lower surface 121 of the tongue plate 12 and partly protruding into the first mating cavity 120, and the connecting portion 22 exposed to a rear end of base portion 11. A pair of blocks 118 are formed on opposite sides of the opening 1101 for preventing over-insertion of an electrical plug.

Referring to FIG. 2 and FIG. 4, the optical device 4 includes a block shaped body portion 41 and a pair of latches 42 extending rearward from opposite sides of a front section of the body portion 41. The latches 42 are spaced to the body portion 41 and obtain a predetermined flexibility. A pair of lenses 44 for receiving optical signals are formed on a front surface of the body portion 41, beside each of which a guiding post 43 is formed and protrudes forwardly. The optical device 4 is inserted into the assembling groove 110 along the mating direction, with the pair of latches 42 being pressed inwardly by inner walls of the assembling groove 110, and the pair of lenses 44 and guiding posts 43 exposed in the first mating cavity 120 via the opening 1101. The guiding posts 43 extend further to guide an optical plug to be inserted and accomplish the optical signal transmission. The optical device 4 is retained under the tongue plate 12, and the contacting portions 23 face to the guiding posts 43. Further, the pair of blocks 118 stand in front of the pair of guiding posts 43 so as to protect the optical device 4.

In the present invention, the optical device 4 and the second terminal group 2 utilize the base portion 11 and the first mating cavity 120 to respectively define two different mating cavities for receiving the optical plug or the electrical plug, that means the first mating cavity 120 can not only receive the electrical plug, such as a USB 2.0 plug, but also receive the optical plug, even combined with a USB 2.0 plug. In conclusion, the connector assembly is multi-functional and configured as a compact structure. The key in optical interconnection mainly relies upon precisely alignment between the coupling lenses, if the alignment is altered, such as additional functions are added onto the connector assembly, the transmission of light therebetween may be negatively affected.

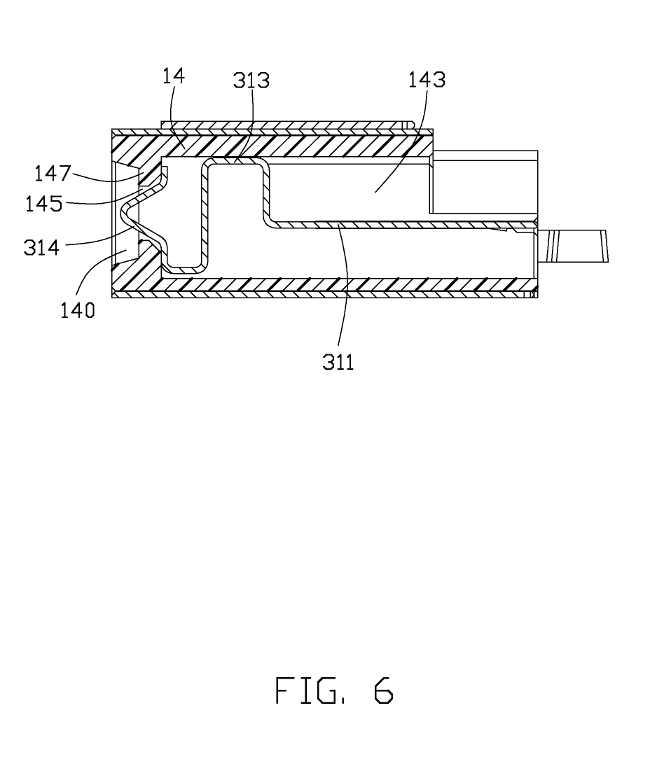

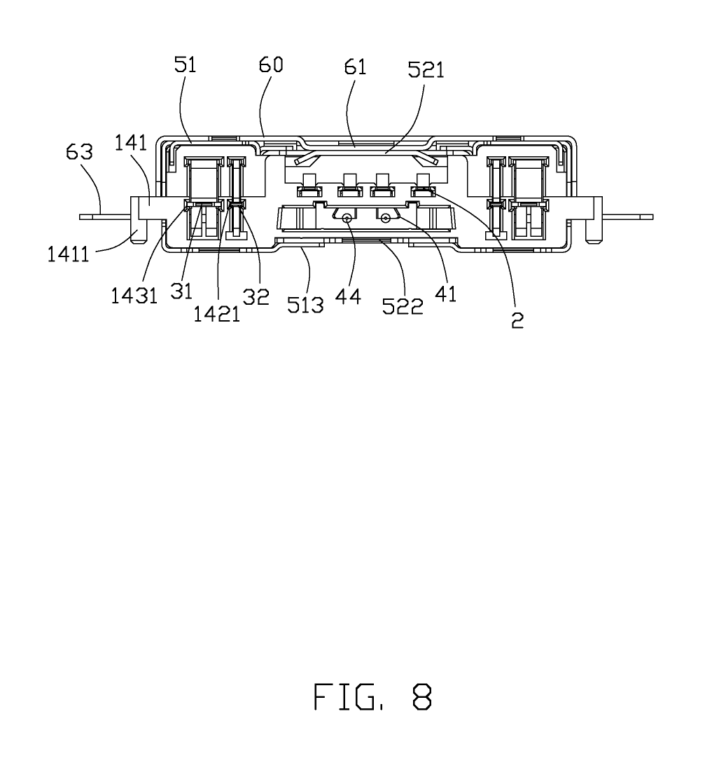

Referring to FIG. 1, FIG. 2, FIG. 6, FIG. 7 and FIG. 8, the first terminal group 3 comprises a pair of power terminals 31 and a pair of signal terminals 32. Certainly, the first terminal group 3 can also include other different terminals, even magnet elements for cooperating with a mating magnetic plug. One power terminal 31 and one signal terminal 32 are arranged in the first body 14, and one power terminal 31 and one signal terminal 32 are also arranged in the second body 13 and symmetrically arranged with respect to the first body 14. Each power terminal 31 comprises a wide plate shaped body portion 311, a connecting portion 312 horizontally extending rearwardly from one end of the body portion 311, a retaining portion 313 extending upwardly from the other end of the body portion 311, and then extending horizontally and bent downwardly, and a resilient contacting portion 314 extending upwardly from a front end of the retaining portion 313, and then protruding outwardly to form an arc shape. The distal end of the resilient contacting portion 314 is breakaway so as to form a two-points-contacting configuration. The power terminal 31 is inserted into the second terminal groove 143 along the mating direction, with the body portion 311 retained in the second transverse groove 1431, and the contacting portion 314 abutting against a stopper 147 formed at a front end of the second terminal groove 143 and partly exposed in the recess section 140. The contacting portions 314 define a contacting surface in the vertical direction perpendicular to the mating direction, which means the electrical plug is mated with the contacting portions 314 in a surface-contacting manner and the spring force therebetween is limited. More importantly, as the power terminals 31 are symmetrically arranged at opposite sides of the first mating cavity 120, the spring force exerts on the mating plug along the longitudinal direction will be counteracted, therefore balance control between the connector assembly and the mating plug becomes easily.

The width of the signal terminal 32 is narrower than that of the power terminal 31, while the basic structures are the same. Each signal terminal 32 comprises a body portion 321, a connecting portion 322 horizontally extending rearwardly from one end of the body portion 321, a retaining portion 323 extending upwardly from the other end of the body portion 321, and then extending horizontally and bent downwardly, and a resilient contacting portion 324 extending upwardly from a front end of the retaining portion 323, and then protruding outwardly to form an arc shape. The signal terminal 32 inserts into the first terminal groove 142 along the mating direction, with the body portion 321 retained in the first transverse groove 1421, and the contacting portion 324 extending forwardly to be exposed in the recess section 140. As the signal terminals 32 are symmetrically arranged at opposite sides of the first mating cavity 120, the spring force exerts on the mating plug along the longitudinal direction will be counteracted, therefore balance control between the connector assembly and the mating plug becomes easily.

In the present invention, the power terminals 31 and signal terminals 32 together with the insulative housing 1 form a non-standard power socket, which adds a power supply function to the connector assembly under condition that the mating balance between the connector assembly and the mating plug is under control. Further, the contacting portions 314, 324 are located in front of the optical device 4 in the mating direction and the optical signal transmission will not be interrupted.

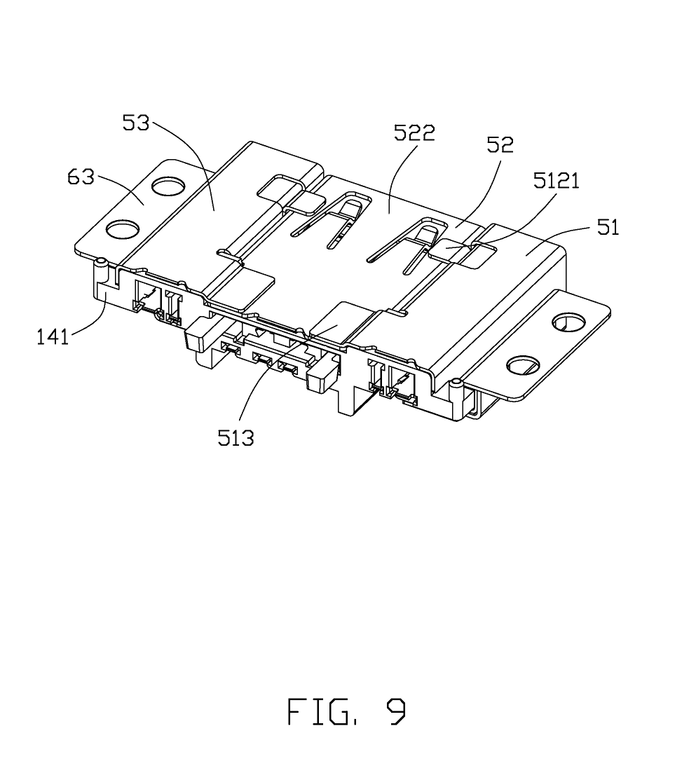

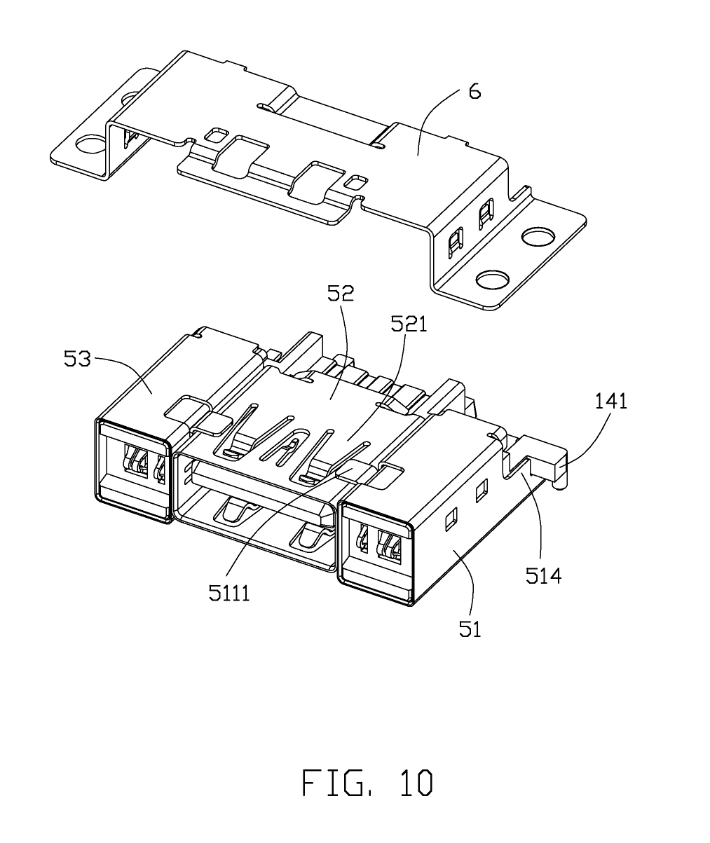

Referring to FIG. 2, FIG. 3, FIG. 9 and FIG. 10, the metallic shell 5 comprises a first shell 51 and a second shell 53 surrounding the first body 14 and the second body 13, and a third shell 52 surrounding the base portion 11 for defining the first mating cavity 120. The height of the base portion 11 is lower than that of the first body 14 and the second body 13. The third shell 52 comprises a first side wall 521 and a second side wall 522 opposite to the first side wall 521, between which the first mating cavity 120 is defined. As the first shell 51 and the second shell 53 are symmetrical to each other with respect to the third shell 52, detail description will focus on the first shell 51 for simplification. The first shell 51 comprises a first side wall 511 and a second side wall 512 oppositely arranged, from each front side edge of which, soldering plate 5111, 5121 extend toward the third shell 52. Further, a soldering plate 513 is also formed at a rear side edge of the second side wall 512. The first shell 51, the second shell 53 and the third shell 52 are combined together by a soldering method, therefore the strength of the connector assembly can be enhanced. Further, a step shaped holding portion 514 is formed at the rear end of the first shell 51 for locking with supporting section 141 on the base portion 11.

The metallic bracket 6 rides on the insulative housing 1, and comprises a plate section 60 and a pair of mounting sections 63 perpendicularly extending downward from opposite ends of the plate section 60. The mounting sections 63 are hanging outside the first body 14 and the second body 13 for cooperating with the supporting section 141. A pair of through holes 630 are defined on the mounting sections 63 for assembling retaining elements such as nuts when the connector assembly is mounted onto the printed circuit board. As the third shell 52 is lower than the first and second shells 51, 53, the metallic bracket 6 forms an abutting portion 61 abutting against the first side wall 521 of the third shell 52, and a bending portion 62 extending forwardly, which can be best shown in FIG. 8.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A connector assembly defining a longitudinal direction and a mating direction perpendicular to the longitudinal direction, comprising:
an insulative housing having a base portion extending along the longitudinal direction, and a first body and a second body located at opposite sides of the base portion and protruding beyond the base portion along the mating direction thereby defining a first mating cavity therebetween;
an optical device retained on the base portion, with a pair of lenses projecting into the first mating cavity;
a first terminal group retained in the base portion with contacting portions located above the lenses in a vertical direction perpendicular to the longitudinal direction and mating direction; and
a second terminal group, respectively retained in the first and second bodies and arranged as a symmetrical manner with respect to the base portion.

2. The connector assembly as described in claim 1, wherein the second terminal group comprises resilient contacting portions projecting forwardly so as to define a mating surface in the vertical direction perpendicular to the mating direction, and said resilient contacting portions are located in front of said lenses.

3. The connector assembly as described in claim 2, wherein the first and second bodies respectively define a recess section at a front end thereof for receiving said resilient contacting portions.

4. The connector assembly as described in claim 1, wherein the base portion has a tongue plate extending toward the first mating cavity, and said contacting portions of the first terminal group are retained in the tongue plate.

5. The connector assembly as described in claim 4, wherein an assembling groove is defined under the tongue plate for receiving said optical device, said pair of lenses exposed in the first mating cavity via a pair of openings defined at a front end of the assembling groove.

6. The connector assembly as described in claim 5, wherein a pair of guiding posts are formed at opposite sides of said lenses and projecting into the first mating cavity via said openings.

7. The connector assembly as described in claim 5, wherein a pair of blocks are formed on the base portion at opposite sides of said openings.

8. The connector assembly as described in claim 1, wherein the base portion is lower than the first and second bodies in the vertical direction.

9. The connector assembly as described in claim 8, wherein three metallic shells are respectively provided to surround the base portion, the first body and the second body.

10. The connector assembly as described in claim 9, wherein a metallic bracket is provided and rides on the three metallic shells, with a pair of mounting sections hanging at opposite sides of the insulative housing for mounting the connector assembly onto a printed circuit board.

11. A connector assembly comprising:
an insulative housing defining an assembling groove extending along a mating direction and a first mating cavity defined in front of the assembling groove and in communication with the assembling groove, a first body and a second body respectively formed at opposite longitudinal ends of the first mating cavity;
an optical device, received in said assembling groove with at least one lens exposed into the first mating cavity; and
power terminals, respectively retained in the first and second bodies and arranged as a symmetrical manner.

12. The connector assembly as described in claim 11, wherein a tongue plate extends forward from the insulative housing and located between the first and second bodies and above said assembling groove, on which a plurality of terminals are retained.

13. The connector assembly as described in claim 12, wherein a recess portion is formed at a front end of each first and second bodies for receiving contacting portions of the power terminals.

14. The connector assembly as described in claim 13, wherein each of said contacting portions is configured as two-points-contacting type and defines a mating surface perpendicular to the mating direction.

15. The connector assembly as described in claim 13, wherein magnetic elements are provided on the first and second bodies.

16. The connector assembly as described in claim 12, wherein a pair of blocks are formed on the insulative housing and located in front of the lens for preventing over-insertion of a mating plug.

17. An electrical connector comprising:
a one piece insulative housing defining a base portion with a mating tongue extending forwardly therefrom, and a pair of side bodies located by two sides of the mating tongue in a transverse direction;
a plurality of contacts disposed in the base portion with resilient contacting sections exposed upon the mating tongue;
an optical module disposed in the base portion behind the mating tongue;
two sets of power contacts disposed in the pair of corresponding side bodies with resilient contacting portions exposed to an exterior, respectively; wherein
the contacting sections exert forces in a vertical direction perpendicular to said vertical direction while the contacting portions exert forces in a forward direction perpendicular to both said vertical direction and said transverse direction.

18. The electrical connector as claimed in claim 17, further including a center metallic shell enclosing the mating tongue for defining a mating port, and a pair of side metallic shells enclosing the pair of corresponding side bodies, respectively.

19. The electrical connector as claimed in claim 18, further including a metallic bracket grasps the pair of side metallic shells and covers the center metallic shell, wherein said bracket defines a supporting face for fastening to an external part so as to assure the housing in position.

20. The electrical connector as claimed in claim 18, wherein the center metallic shell is dimensioned smaller than that of the pair of side metallic shells in the vertical direction.
